(19) United States
(12) Patent Application Publication
(10) Pub. No.: US 2026/0261704 A1
(43) Pub. Date: Sep. 3, 2026

(54) IMAGE PROCESSING

(71) Applicant: Tencent Technology (Shenzhen) Company Limited, Shenzhen (CN)

(72) Inventor: Xiaozhong XU, Shenzhen (CN)

(73) Assignee: Tencent Technology (Shenzhen) Company Limited, Shenzhen, GD (CN)

(21) Appl. No.: 19/674,218

(22) Filed: May 12, 2026

Related U.S. Application Data
(63) Continuation of application No. PCT/CN2025/130773, filed on Oct. 29, 2025.

(30) Foreign Application Priority Data
Dec. 3, 2024 (CN) 202411770841.0

(51) Int. Cl. H04N 19/52; H04N 19/105; H04N 19/139; H04N 19/167; H04N 19/176

(52) U.S. Cl. CPC H04N 19/52; H04N 19/105; H04N 19/139; H04N 19/167; H04N 19/176

(57) ABSTRACT

Some aspects of the disclosure provide a method of image processing. In some examples, based on a motion vector of a reference block in a first reference picture of a current picture and a position of the reference block in the first reference picture, a current block in the current picture corresponding to the reference block is determined. A matching relationship between the first reference picture and a second reference picture that is used in an inter prediction for the current picture is determined. Based on the matching relationship and the motion vector of the reference block, a first motion vector predictor of the current block is generated. Apparatus and non-transitory computer-readable storage medium counterpart embodiments are also contemplated.

### RELATED APPLICATIONS

The present application is a continuation of International Application No. PCT/CN2025/130773, filed on Oct. 29, 2025, which claims priority to Chinese Patent Application No. 202411770841.0, filed on Dec. 3, 2024. The entire disclosures of the prior applications are hereby incorporated by reference.

### FIELD OF THE TECHNOLOGY

This disclosure relates to the technical field of video processing, including image processing methods, image processing apparatuses, electronic devices, non-transitory computer-readable storage media, and program products.

### BACKGROUND

To accommodate large-scale data transmission of video data, original video data needs to be coded on a data transmitting end, to form a compressed data bitstream. After the data bitstream is transmitted to a data receiving end, the data bitstream is further decoded, to restore predicted reconstructed video data.

In a predictive coding stage of video coding and decoding, inter prediction may employ temporal motion vector prediction (TMVP). TMVP mainly predicts a motion vector of a current block in a current image (also referred to as current picture) by using a motion vector of a co-located block in a reference image (also referred to as reference picture). The co-located block refers to a block having the same position in the reference image as a position of the current block in the current image. Typically, a motion vector predictor of the current block is derived from motion vectors of blocks neighboring the co-located block.

However, if the current block and the co-located block correspond to different objects, a motion correlation between the current block and the co-located block is significantly reduced. Therefore, accuracy of predicting the motion vector of the current block based on the motion vector of the co-located block is relatively low, thereby affecting accuracy and efficiency of coding the current block, and resulting in relatively low reliability of image-based data processing.

### SUMMARY

Embodiments of this disclosure include an image processing method, an image processing apparatus, an electronic device, a computer-readable storage medium (e.g., non-transitory computer-readable storage medium), and a computer program product, optimizing TMVP of a current block and improving coding and decoding accuracy.

Some aspects of the disclosure provide a method of image processing. In some examples, based on a motion vector of a reference block in a first reference picture of a current picture and a position of the reference block in the first reference picture, a current block in the current picture corresponding to the reference block is determined. A matching relationship between the first reference picture and a second reference picture that is used in an inter prediction for the current picture is determined. Based on the matching relationship and the motion vector of the reference block, a first motion vector predictor of the current block is generated.

Some aspects of the disclosure provide an apparatus that includes processing circuitry configured to perform any of the methods described herein.

Some aspects of the disclosure provide a non-transitory computer-readable storage medium storing instructions which when executed by at least one processor cause the at least one processor to perform any of the methods described herein.

In an aspect, the embodiments of this disclosure include an image processing method, performed by an electronic device, including: determining, based on a motion vector of a reference block in a first reference image and a position of the reference block in the first reference image, a current block corresponding to the reference block in a current image; determining a matching relationship between the first reference image and a second reference image, the second reference image being configured for performing inter prediction on the current image; and generating, based on the matching relationship and the motion vector of the reference block, a first motion vector predictor of the current block.

In another aspect, the embodiments of this disclosure include an image processing apparatus, including: a first determining module, configured to determine, based on a motion vector of a reference block in a first reference image and a position of the reference block in the first reference image, a current block corresponding to the reference block in a current image; a second determining module, configured to determine a matching relationship between the first reference image and a second reference image, the second reference image being configured for performing inter prediction on the current image; and a generation module, configured to generate, based on the matching relationship and the motion vector of the reference block, a first motion vector predictor of the current block.

In another aspect, the embodiments of this disclosure include an electronic device, including at least one processor (an example of processing circuitry); and a memory, configured to store at least one computer program, the at least one computer program, when executed by the at least one processor, causing the electronic device to implement the image processing method described above.

In another aspect, the embodiments of this disclosure include a non-transitory computer-readable storage medium, having computer-readable instructions stored therein, the computer-readable instructions, when executed by a processor of a computer, implementing the image processing method described above.

In another aspect, the embodiments of this disclosure include a computer program product or a computer program, including computer instructions. The computer instructions are stored in a computer-readable storage medium. A processor of the computer device reads the computer instructions from the computer-readable storage medium, and the processor executes the computer instructions to cause the computer device to perform the above image processing method.

### BRIEF DESCRIPTION OF THE DRAWINGS

FIG. 1 shows a schematic diagram of a system architecture to which technical solutions in embodiments of this disclosure may be applied.

FIG. 2 shows an example of an arrangement mode of a video coding apparatus and a video decoding apparatus in a streaming environment.

FIG. 3 shows a basic flowchart of an example of a coding process performed by a video coder.

FIG. 4 shows a schematic diagram of an example of TMVP.

FIG. 5 shows a flowchart of an example of an image processing method.

FIG. 6A to FIG. 6D show schematic diagrams of example correspondence relationships between reference blocks in a first reference image and current blocks in a current image.

FIG. 7 shows a flowchart of an example of an image processing method.

FIG. 8 shows a flowchart of an example of an image processing method.

FIG. 9 shows a flowchart of an example of an image processing method.

FIG. 10A to FIG. 10D show schematic diagrams of an example of a prediction reference image, a co-located reference image, and a current image.

FIG. 11 shows a block diagram of an example of an image processing apparatus.

FIG. 12 shows a schematic structural diagram of an example of an electronic device suitable for implementing embodiments of this disclosure.

### DETAILED DESCRIPTION

The following describes technical solutions in embodiments of this disclosure with reference to the accompanying drawings. The described embodiments are some of the embodiments of this disclosure rather than all of the embodiments. Other embodiments are within the scope of this disclosure.

Examples of terms involved in the aspects of the disclosure are briefly introduced below. The descriptions of the terms are provided as examples and are not intended to limit the scope of the disclosure.

Block diagrams shown in the accompanying drawings are functional entities and do not necessarily correspond to physically independent entities. That is, the functional entities may be implemented in a software form, or in at least one hardware module or integrated circuit, or in different networks and/or processor apparatuses and/or microcontroller apparatuses.

Flowcharts shown in the accompanying drawings are example descriptions, do not need to include all content and operations/steps, and do not need to be performed in described orders either. For example, some operations/steps may be further divided, while some operations/steps may be combined or partially combined. Therefore, an actual performance order may change according to an actual case.

“A plurality of” mentioned in this disclosure means two or more. “And/or” describes an association relationship between associated objects and represents that three relationships may exist. For example, A and/or B may represent the following three cases: Only A exists, both A and B exist, and only B exists. The character “/” generally represents an “or” relationship between associated objects before and after it.

In the specification, claims, and accompanying drawings of this disclosure, the terms “first”, “second”, “third”, “fourth”, and the like are intended to distinguish between different objects, instead of describing a particular order. The terms “include”, “have”, and any variant thereof are intended to cover a non-exclusive inclusion. For example, a process, method, system, product, or device that includes a series of operations or units is not limited to the listed operations or units, but instead, further includes operations or units that are not listed in some embodiments, or further includes other operations or units inherent to the process, the method, the product, or the device in some embodiments.

In the embodiments of this disclosure, the term “module” or “unit” refers to a computer program with a preset function or a part of the computer program and works, together with other related parts, to implement a preset target, and may be completely or partially implemented by using software, hardware (for example, a processing circuit or a memory) or a combination thereof. Similarly, one processor (or a plurality of processors or memories) may be configured to implement at least one module or unit. Furthermore, the module or unit may be a part of an integrated module or unit that includes the functionality of the module or unit.

For ease of understanding the technical solutions provided in the embodiments of this disclosure, an image-based data processing process is first described.

Video coding refers to processing a picture sequence forming a video or a video sequence. In the field of video coding, the terms “picture”, “frame”, or “image” may be used as synonyms. Video coding used in the embodiments of this disclosure represents video coding or video decoding. Video coding is performed at a source side, and includes processing (for example, by compressing) an original video image to reduce a data volume required for representing the video image, thereby storing and/or transmitting more efficiently. Video decoding is performed at a destination side, and includes performing an inverse process relative to a coder, to reconstruct a video image. “Coding” of a video frame referred to in the embodiments relates to “coding” or “decoding” of a video image sequence. A combination of a coding part and a decoding part is also referred to as codec (coding and decoding).

Each image in the video image sequence is split into a set of non-overlapping blocks and is coded at a block level. In other words, at a coder side, video is coded at the block (also referred to as image block or video block) level, for example, by spatial (intra-image) prediction and temporal (inter-image) prediction to generate a prediction block, subtracting the prediction block from a current block (a block currently being processed or to be processed) to acquire a residual block, transforming and quantizing the residual block in a transform domain to reduce a data volume to be transmitted (compressed).

At a decoder side, an inverse processing part relative to a coder is applied to a coded or compressed block to reconstruct the current block.

In addition, the coder copies processing in the decoder, so that the coder and the decoder generate the same prediction (for example, intra prediction and inter prediction) and/or reconstruction for coding a subsequent block.

The term “block” is a part of an image or a frame. In the embodiments of this disclosure, the current block refers to a block currently being processed. For example, in coding, the current block refers to a block currently being coded; and in decoding, the current block refers to a block currently being decoded.

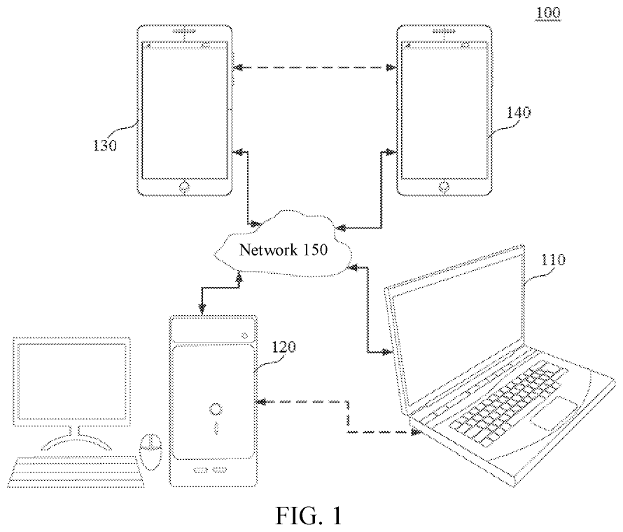

FIG. 1 shows a schematic diagram of a system architecture to which technical solutions in embodiments of this disclosure may be applied. As shown in FIG. 1, a system architecture 100 includes a plurality of terminal apparatuses, and the plurality of terminal apparatuses may communicate with one another through, for example, a network 150. For example, the system architecture 100 may include a first terminal apparatus 110 and a second terminal apparatus 120 that are connected to each other through the network 150. In an embodiment of FIG. 1, the first terminal apparatus 110 and the second terminal apparatus 120 perform unidirectional data transmission.

For example, the first terminal apparatus 110 may code video data (e.g., a video picture stream captured by the terminal apparatus 110) for transmission to the second terminal apparatus 120 by using the network 150. Coded video data is transmitted in a form of at least one coded video bitstream. The second terminal apparatus 120 may receive the coded video data from the network 150, decode the coded video data to restore the video data, and display video pictures based on the restored video data.

In an embodiment of this disclosure, the system architecture 100 may include a third terminal apparatus 130 and a fourth terminal apparatus 140 that perform two-way transmission of the coded video data. The two-way transmission may occur, for example, during a video conference. For two-way data transmission, each of the third terminal apparatus 130 and the fourth terminal apparatus 140 may code video data (e.g., a video picture stream captured by the terminal apparatus) for transmission to the other of the third terminal apparatus 130 and the fourth terminal apparatus 140 by using the network 150. Each of the third terminal apparatus 130 and the fourth terminal apparatus 140 may further receive coded video data transmitted by the other of the third terminal apparatus 130 and the fourth terminal apparatus 140, may decode the coded video data to restore the video data, and may display video pictures on an accessible display apparatus based on the restored video data.

In the embodiment of FIG. 1, the first terminal apparatus 110, the second terminal apparatus 120, the third terminal apparatus 130, and the fourth terminal apparatus 140 may be servers, personal computers, and smart phones, but the principles disclosed in this disclosure are not limited thereto. The embodiment disclosed in this disclosure is applicable to a laptop computer, a tablet computer, a media player, and/or a dedicated video conference device. The network 150 represents any number of networks that transmit the coded video data among the first terminal apparatus 110, the second terminal apparatus 120, the third terminal apparatus 130, and the fourth terminal apparatus 140, including, for example, wired and/or wireless communication networks. The network 150 may exchange data in a circuit-switched channel and/or a packet-switched channel. The network may include a telecommunication network, a local area network, a wide area network, and/or the Internet. For purposes of this disclosure, an architecture and a topology of the network 150 may be insignificant for operations disclosed in this disclosure, unless explained below.

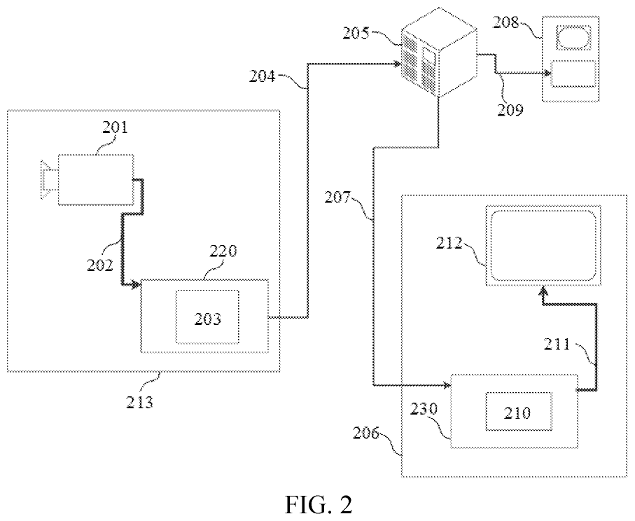

FIG. 2 shows an arrangement mode of a video coding apparatus and a video decoding apparatus in a streaming environment. The subject disclosed in this disclosure is equivalently applicable to other applications supporting videos, including, for example, a video conference, a digital television (TV), and storage of a compressed video in a digital medium including a compact disc (CD), a digital video disk (DVD), and a memory stick.

A streaming system may include a capture subsystem 213. The capture subsystem 213 may include a video source 201, such as a digital camera. The video source creates an uncompressed video picture stream 202. In this embodiment, the video picture stream 202 includes samples that are taken by the digital camera. Compared with coded video data 204 (or a coded video bitstream 204), the video picture stream 202 is depicted as a bold line to emphasize a video picture stream with a high data volume. The video picture stream 202 may be processed by an electronic apparatus 220. The electronic apparatus 220 includes a video coding apparatus 203 coupled to the video source 201. The video coding apparatus 203 may include hardware, software, or a combination of software and hardware, to implement or carry out each aspect of the disclosed subject described below in further detail. Compared with the video picture stream 202, the coded video data 204 (or the coded video bitstream 204) is depicted as a thin line to emphasize the coded video data 204 (or the coded video bitstream 204) with a low data volume, and may be stored in a streaming server 205 for future use. At least one streaming client subsystem, for example, a client subsystem 206 and a client subsystem 208 in FIG. 2, may access the streaming server 205 to retrieve a copy 207 and a copy 209 of the coded video data 204. The client subsystem 206 may include, for example, a video decoding apparatus 210 in an electronic apparatus 230. The video decoding apparatus 210 decodes the incoming copy 207 of the coded video data, and generates an output video picture stream 211 that may be presented on a display 212 (for example, a display screen) or another presentation apparatus. In some streaming systems, the coded video data 204, the video data 207, and the video data 209 (for example, a video bitstream) may be coded according to some video coding/compression standard.

The electronic apparatus 220 and the electronic apparatus 230 may include other components not shown in this figure. For example, the electronic apparatus 220 may include a video decoding apparatus, and the electronic apparatus 230 may further include a video coding apparatus.

In an embodiment of this disclosure, international video coding standards High Efficiency Video Coding (HEVC, H.265) and Versatile Video Coding (VVC, H.266), and a China national video coding standard Audio Video Coding Standard (AVS) are used as an example. After a video frame image is input, the video frame image may be partitioned into a plurality of non-overlapping processing units based on a block size, and a similar compression operation is performed on each processing unit. The processing unit is referred to as a coding tree unit (CTU) or a largest coding unit (LCU). The CTU may continue to be further partitioned to obtain at least one basic coding unit (CU), and the CU is the most basic element in a coding phase.

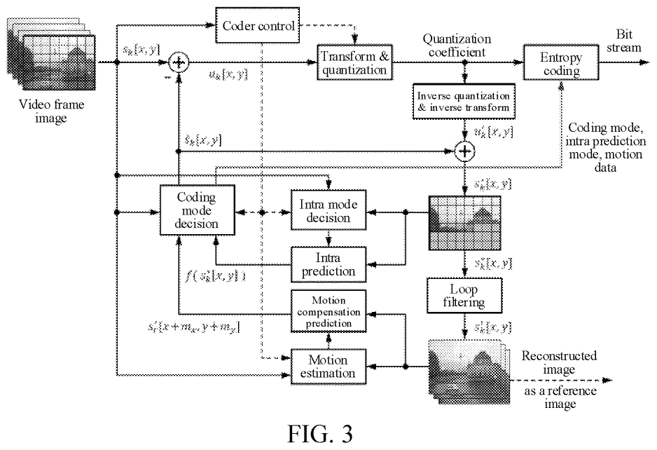

FIG. 3 shows a basic flowchart of a coding process performed by a video coder. In this process, intra prediction is used as an example for description.

A difference operation is performed on an original image signal sₖ[x, y] and a predicted image signal ŝₖ[x, y] to obtain a residual signal uₖ[x, y]. The residual signal uₖ[x, y] is then transformed and quantized to obtain a quantization coefficient. Entropy coding is performed on the quantization coefficient to obtain a coded bit stream, and inverse quantization and inverse transform are performed to obtain a reconstructed residual signal u′ₖ[x, y]. The predicted image signal ŝₖ[x, y] and the reconstructed residual signal u′ₖ[x, y] are superimposed to generate an image signal sₖ*[x, y]. The image signal sₖ*[x, y] is inputted to an intra mode decision module and an intra prediction module for intra prediction, and is further subjected to loop filtering to output a reconstructed image signal s′ₖ[x, y]. The reconstructed image signal s′ₖ[x, y] may be used as a reference image for a next frame for motion estimation and motion compensation prediction. Then, a predicted image signal ŝₖ[x, y] of the next frame is obtained based on a motion compensation prediction result s′ᵣ[x+mₓ, y+m_{y}] and an intra prediction result

$$f ( {s}_{k}^{*} [ x , y ] ) .$$

The above process continues to be repeated until the coding is completed.

Coding operations for the CU involved in the foregoing video coding process are introduced in further detail as follows.

Predictive coding: Predictive coding includes an intra prediction mode, an inter prediction mode, and the like. After an original video signal is predicted by a selected reconstructed video signal, a residual video signal is obtained. A coding side needs to determine a predictive coding mode to be selected for a current CU, and notify a decoding side. Intra prediction means that a predicted signal is from a coded-reconstructed region in the same image. Inter prediction means that a predicted signal is from another coded image (referred to as a reference image) different from a current image. In inter prediction, a prediction block of a current block is generated from a reference block in the coded image (referred to as a reference frame or a reference image) (motion compensation). A process of searching for an optimal reference block in a reference frame is referred to as motion estimation. A difference in image coordinates between the reference block and the current block is referred to as a motion vector (MV).

Transform & Quantization: After a transform operation such as discrete Fourier transform (DFT) and discrete cosine transform (DCT) is performed on the residual video signal, the signal is converted into a transform domain to obtain a transform coefficient. A lossy quantization operation is further performed on the transform coefficient with specific information lost, so that a quantized signal is favorable for compression and expression. In some video coding standards, there may be more than one transform mode for selection, so that the coding side also needs to select one transform mode for the current CU, and notify the decoding side. Fineness of quantization is determined by a quantization parameter (QP). A larger value of the QP represents that coefficients in a larger value range are to be quantized into the same output, thereby resulting in greater distortion and a low bit rate. On the contrary, a small value of the QP represents that coefficients in a small value range are to be quantized into the same output, thereby resulting in a small distortion and a high bit rate.

Entropy coding or statistical coding: Statistical compressed coding is performed on a quantized transform-domain signal based on a frequency of occurrence of each value to finally output a binarized (0 or 1) compressed bitstream. In addition, entropy coding also needs to be performed on other information generated through coding, for example, a selected coding mode and motion vector data, to reduce the code rate. Statistical coding is a lossless coding mode that may effectively reduce a bit rate required for expressing the same signal. A common statistical coding mode includes variable length coding (VLC) or context adaptive binary arithmetic coding (CABAC).

A process of the CABAC includes three operations: binarization, context modeling, and binary arithmetic coding. After binarization is performed on an input syntactic element, binary data may be coded in a normal coding mode and a bypass coding mode. In a bypass coding mode, assigning a specific probabilistic model for each binary bit is not required, and a bin value of the input binary bit is directly coded with a simple bypass coder, to accelerate coding and decoding. In some aspects, different syntactic elements are not completely independent, and the same syntactic element has memorability to some extent. Therefore, according to a conditional entropy theory, using other coded syntactic elements for conditional coding may further improve coding performance compared with independent coding or memoryless coding. Coded sign information used as a condition is referred to as a context. In a conventional coding mode, binary bits of the syntactic element sequentially enter a context model. The coder assigns an appropriate probability model for each input binary bit based on a value of a previously coded syntactic element or binary bit. This process is context modeling. A context model corresponding to the syntactic element may be located through a context index increment (ctxIdxInc) and a context index start (ctxIdxStart). After the bin value and the assigned probabilistic model are sent to a binary arithmetic coder together for coding, the context model is updated based on the bin value, which is an adaptive process in coding.

Loop filtering: Operations of inverse quantization, inverse transform, and predictive compensation are performed on a transformed and quantized signal to obtain a reconstructed image. Due to impact of quantization, compared with an original image, some information of the reconstructed image is different from that of the original image, that is, the reconstructed image may have a distortion. Therefore, a filtering operation may be performed on the reconstructed image, for example, by using filters such as a deblocking filter (DB), a sample adaptive offset (SAO), or an adaptive loop filter (ALF), which may effectively reduce a degree of the distortion caused by quantization. Since filtered reconstructed images are to be used as a reference for subsequent image coding to predict future image signals, the above filtering operation is also referred to as loop filtering, that is, a filtering operation in a coding loop.

Based on the above coding process, at the decoding side, for each CU, after a compressed bitstream (i.e., bit stream) is acquired, entropy decoding is performed to obtain various mode information and quantization coefficients. Then, inverse quantization and inverse transform are performed on the quantization coefficients to obtain a residual signal. In another aspect, a predicted signal corresponding to the CU may be obtained according to coding mode information that is known, and the residual signal may be added to the predicted signal to obtain a reconstructed signal. The reconstructed signal is then subjected to operations such as loop filtering to produce a final output signal.

In a predictive coding stage of video coding and decoding, inter prediction may employ TMVP. TMVP mainly predicts a motion vector of a current block in a current image by using a motion vector of a co-located block in a reference image. The co-located block refers to a block having the same position in the reference image as a position of the current block in the current image. At this time, a motion vector predictor of the current block is derived from motion vectors of blocks neighboring the co-located block.

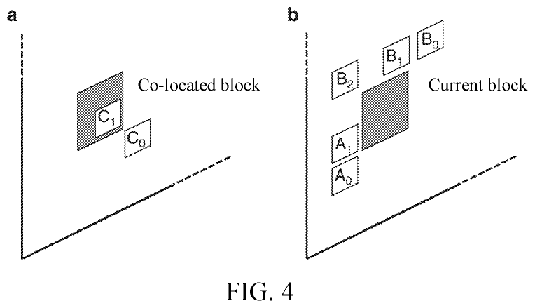

For example, as shown in FIG. 4, b is a current image, which includes a current block and some other blocks (A_0, A_1, B_0, B_1, and B_2), and a is a reference image, which includes a co-located block C_1 and some other blocks (C_0). In some examples, a motion vector predictor of the current block may be derived from a motion vector of C_0 or C_1.

However, if the current block and the co-located block correspond to different objects, a motion correlation between the current block and the co-located block is significantly reduced. Therefore, accuracy of predicting the motion vector of the current block based on the motion vector of the co-located block is relatively low, thereby affecting accuracy and efficiency of coding the current block, and resulting in relatively low reliability of image-based data processing.

Therefore, to improve accuracy of motion vector prediction, so as to improve accuracy and efficiency of coding the current block, and help ensure reliability of image-based data processing, an embodiment of this disclosure includes an image-based data processing solution. A reference block in a reference image is used for derivation to obtain a current block corresponding to the reference block in a current image, thereby establishing a correspondence relationship between the reference block and the current block. The reference block and the current block correspond to the same object, and a motion correlation between the reference block and the current block is relatively high. A motion vector of the current block is then predicted by using a matching relationship between the reference image and another reference image used for performing inter prediction, and a motion vector of the reference block. In this case, the motion vector of the reference block used has a relatively high reference value, thereby improving accuracy of motion vector prediction of the current block, improving accuracy and efficiency of coding the current block, and resulting in high reliability of image-based data processing.

In a specific implementation of this disclosure, user-related data is involved. When the embodiments of this disclosure are applied to specific products or technologies, permission or consent of a user needs to be obtained, and collection, use, and processing of the relevant data need to comply with relevant laws, regulations, and standards of relevant countries and regions.

Various implementation details of the technical solutions of the embodiments of this disclosure are described below in further detail.

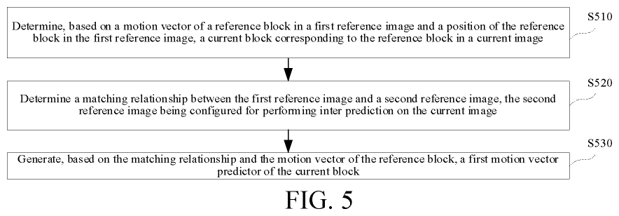

FIG. 5 shows a flowchart of an image processing method according to an embodiment of this disclosure. The image processing method may be performed by an electronic device, for example, a terminal device or a server. The image processing method is a TMVP optimization method, and may be used for inter prediction at a coding side and a decoding side. The embodiment of this disclosure is described by using a method performed by a terminal device as an example. The terminal device may be, for example, the video coding apparatus 203 shown in FIG. 2. As shown in FIG. 5, the image processing method includes at least operations S510 to S530. Descriptions are as follows.

Operation S510: Determine, based on a motion vector of a reference block in a first reference image and a position of the reference block in the first reference image, a current block corresponding to the reference block in a current image.

The current image refers to a to-be-coded image. The reference image refers to another image that has been coded and that is different from the current image. There are a plurality of other images. For the current image, the reference image corresponding to the current image is any one of the plurality of other images.

In the embodiments of this disclosure, the first reference image and a second reference image are reference images corresponding to the current image, and are distinguished by “first” and “second”.

Based on the first reference image as a benchmark, motion of the reference block in the first reference image is derived, thereby obtaining a correspondence relationship between the reference block in the first reference image and the current block in the current image. In this case, an object corresponding to the reference block in the first reference image is the same as an object corresponding to the current block in the current image, and the object may be a moving object or a non-moving object (i.e., a stationary object). If the object is a moving object, the position of the reference block in the first reference image is different from a position of the current block in the current image. If the object is a stationary object, the position of the reference block in the first reference image is the same as the position of the current block in the current image.

In addition, the second reference image is configured for performing inter prediction on the current image.

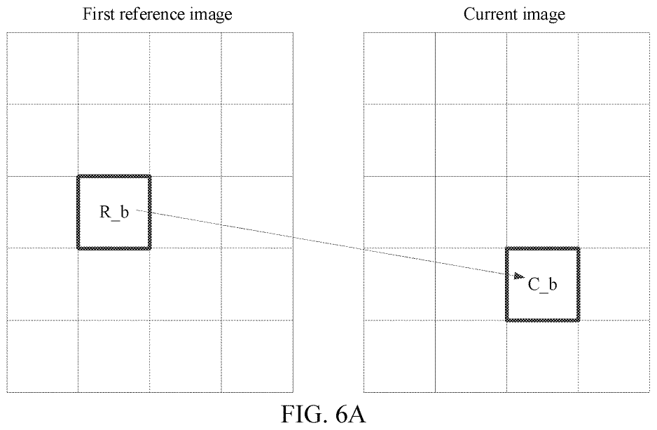

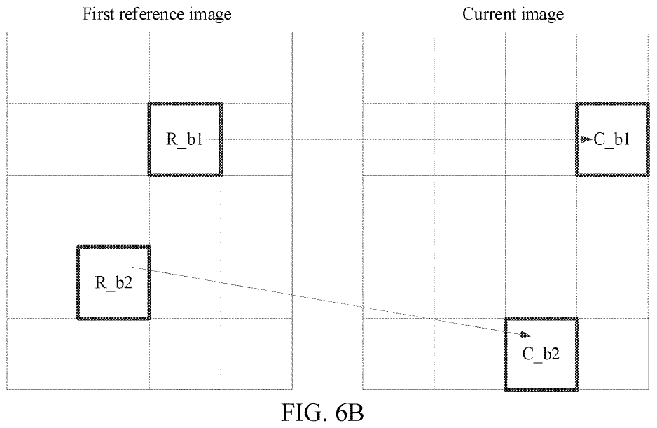

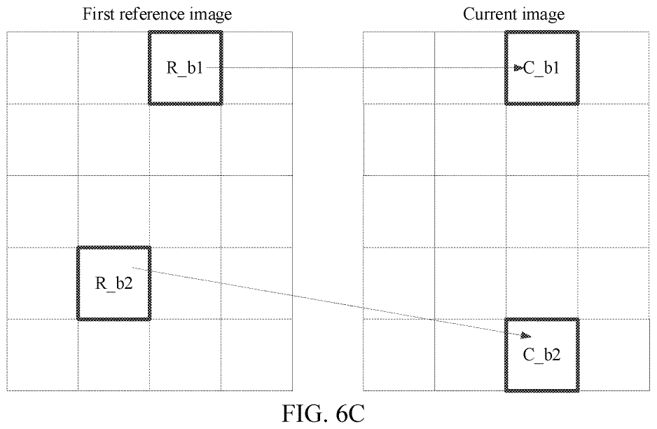

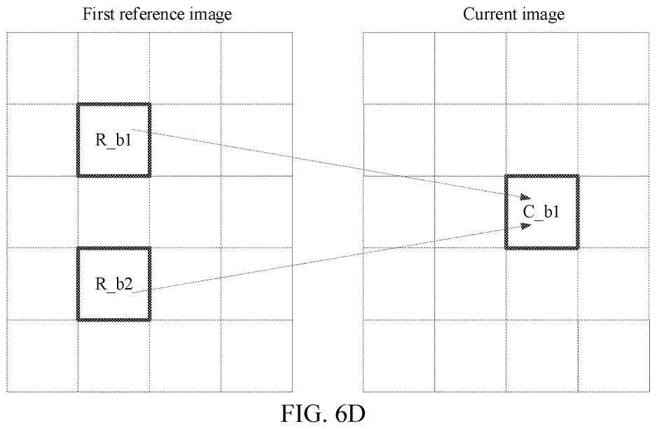

For ease of understanding, FIG. 6A is a schematic diagram of a correspondence relationship between a reference block in a first reference image and a current block in a current image. As shown in FIG. 6A, a reference block R_b in the first reference image corresponds to a current block C_b in the current image. That is, the reference block R_b and the current block C_b correspond to the same object, and the object is a moving object.

In some embodiments, the first reference image may be an image that is relatively close to the current image in spatial position, or an image that is temporally adjacent to the current image. For example, if the current image is an i^{th} frame in a video, an (i−1)^{th} frame in the video may be the first reference image, or an (i+1)^{th} frame in the video may be the first reference image. For example, the first reference image is a co-located reference image corresponding to the current image.

In some embodiments, the first reference image may be an image that is far away from the current image in spatial position, or an image that is temporally distant from the current image. For example, if the current image is an i^{th} frame in a video, an (i−100)^{th} frame in the video may be the first reference image, or an (i+100)^{th} frame in the video may be the first reference image. For example, the first reference image is not a co-located reference image corresponding to the current image.

In a practical application, the first reference image may be selected flexibly according to a specific application scenario.

In the embodiments of this disclosure, the reference block is an image block in the first reference image, and the current block is an image block in the current image. In some embodiments, the image block includes, but is not limited to, at least one of a coding unit, a luma coding unit, a chroma coding unit, a coding block, a luma coding block, a chroma coding block, a prediction unit, a luma prediction unit, a chroma prediction unit, a luma prediction block, or a chroma prediction block.

In the embodiments of this disclosure, the motion vector is a motion vector corresponding to the reference block, and may be calculated by using a TMVP method, and is a motion vector predictor corresponding to the reference block. In other embodiments, the motion vector may alternatively be an actual motion vector value corresponding to the reference block. In a practical application, the motion vector may be adjusted flexibly according to a specific application scenario.

In an embodiment of this disclosure, the motion vector includes a motion vector predictor of the reference block, denoted as MV0=(Δx, Δy), and the position of the reference block in the first reference image includes a position coordinate, denoted as P=(x, y).

Accordingly, in operation S510, the determining, based on a motion vector of a reference block in a first reference image and a position of the reference block in the first reference image, a current block corresponding to the reference block in a current image may include:
calculating, based on the motion vector predictor of the reference block and the position coordinate, a target position coordinate; and
determining an image block indicated by the target position coordinate in the current image as the current block.

The calculating, based on the motion vector predictor of the reference block and the position coordinate, a target position coordinate may include: adding the motion vector predictor and a coordinate value of the same dimension in the position coordinate, to obtain the target position coordinate. In some embodiments, the dimension includes a horizontal dimension and a vertical dimension. The horizontal dimension corresponds to an X axis, and the vertical dimension corresponds to a Y axis. For example, continuing with the foregoing example, let P′ denote the target position coordinate, then P′=(x+Δx, y+Δy).

An image block located at a position corresponding to the target position coordinate in the current image is a target block. For example, in the foregoing example, the image block located at the target position coordinate P′ in the current image is the target block.

Thus, through the above embodiments, the current block corresponding to the reference block in the current image may be simply and accurately obtained, providing strong support for predicting the motion vector of the current block.

Operation S520: Determine a matching relationship between the first reference image and the second reference image, the second reference image being configured for performing inter prediction on the current image.

In this operation, the inter prediction specifically refers to the TMVP method.

In the embodiments of this disclosure, the matching relationship refers to whether the first reference image and the second reference image are the same image. Two cases may be included:

Case 1: The first reference image and the second reference image are the same image.

Case 2: The first reference image and the second reference image are not the same image (i.e., different images).

There may be multiple implementations for determining the matching relationship, including:
1) comparing whether indexes of the first reference image and the second reference image are the same; or
2) comparing whether metadata of the first reference image and metadata of the second reference image are the same, where the metadata may be picture order count (POC) and FrameNum (or Temporal identifier (ID)); or
3) directly comparing, when all decoded reference frames are stored in a DPB in an actual coder/decoder implementation, image pointers or unique IDs.

Operation S530: Generate, based on the matching relationship and the motion vector of the reference block, a first motion vector predictor of the current block.

In the embodiments of this disclosure, the first motion vector predictor of the current block includes a size and a direction.

In an embodiment of this disclosure, an example in which the first reference image is the co-located reference image corresponding to the current image is used. Accordingly, in operation S530, the generating, based on the matching relationship and the motion vector of the reference block, a first motion vector predictor of the current block may include the following two cases:

Case 1: When the matching relationship indicates that the second reference image and the co-located reference image are the same image, the motion vector of the reference block is used as the first motion vector predictor of the current block.

In Case 1, the second reference image and the co-located reference image are the same image. At this time, the motion vector of the reference block may be directly used as the first motion vector predictor of the current block.

Case 2: When the matching relationship indicates that the second reference image and the co-located reference image are different images, the motion vector of the reference block is scaled, to obtain the first motion vector predictor of the current block.

In Case 2, the second reference image and the co-located reference image are different images. At this time, a corresponding scaling (downscaling or upscaling) needs to be performed on the motion vector of the reference block, to obtain the first motion vector predictor of the current block.

For Case 2, in an embodiment of this disclosure, the scaling the motion vector of the reference block to obtain the first motion vector predictor of the current block may include:
acquiring a first distance between the current image and the co-located reference image, and a second distance between the current image and the second reference image; and
scaling, based on the first distance and the second distance, the motion vector of the reference block to obtain the first motion vector predictor.

That is, in an embodiment, the distances between the current image and the co-located reference image and between the current image and the second reference image are acquired first, and then the motion vector of the reference block is scaled by using the two distances, to obtain the first motion vector predictor of the current block.

Thus, through implementation of the embodiment, the first motion vector predictor of the current block is calculated by using the distances between the current image and the co-located reference image and between the current image and the second reference image, taking into account relative distance relationships between the current image and the co-located reference image and between the current image and the second reference image, thereby improving accuracy of motion vector prediction of the current block.

In an embodiment, the acquiring a first distance between the current image and the co-located reference image, and a second distance between the current image and the second reference image may include:
acquiring a first display position of the co-located reference image in a video, a second display position of the second reference image in the video, and a third display position of the current image in the video;
determining, based on the third display position and the first display position, the first distance; and
determining, based on the third display position and the second display position, the second distance.

In an embodiment, the co-located reference image, the second reference image, and the current image are images within the same video. Therefore, in the embodiment, the display positions of the co-located reference image, the second reference image, and the current image in the video are acquired first, and then the first distance and the second distance are determined by using pairwise positions.

In an embodiment, the first display position of the co-located reference image in the video may be represented by the frame number of the co-located reference image in the video. For example, the co-located reference image is a j^{th} frame in the video. Similarly, the second display position of the second reference image in the video may be represented by the frame number of the second reference image in the video, and the third display position of the current image in the video may be represented by the frame number of the current image in the video.

Accordingly, in an embodiment, the first distance is determined based on the third display position and the first display position. The determining, based on the third display position and the second display position, the second distance may include:
determining an absolute value of a difference between the frame number corresponding to the current image and the frame number corresponding to the co-located reference image as the first distance between the current image and the co-located reference image; and
determining an absolute value of a difference between the frame number corresponding to the current image and the frame number corresponding to the second reference image as the second distance between the current image and the second reference image.

For example, the co-located reference image is a (j_r1)^{th} frame in the video, the second reference image is a (j_r2)^{th} frame in the video, the current image is a (j_c)^{th} frame in the video, and the first distance between the current image and the co-located reference image is represented by d0, where d0=|J_c−j_r1|; and the second distance between the current image and the second reference image is represented by d1, where d1=|j_c−j_r2|.

Thus, through implementation of the embodiment, the distances between the current image and the co-located reference image and between the current image and the second reference image may be simply and accurately obtained, providing strong support for the scaling of the motion vector of the reference block.

In an embodiment, the scaling, based on the first distance and the second distance, the motion vector of the reference block to obtain the first motion vector predictor may include:
multiplying a ratio obtained by dividing the first distance by the second distance by the motion vector of the reference block to obtain the first motion vector predictor.

That is, in the embodiment, the ratio of the first distance to the second distance is calculated, to obtain a distance ratio, and then the distance ratio and the motion vector of the reference block are multiplied, to obtain the first motion vector predictor of the current block.

For example, continuing with the foregoing example, the first distance d0 between the current image and the co-located reference image, the second distance d1 between the current image and the second reference image, and a motion vector predictor MV0 corresponding to the reference block are obtained. The first motion vector predictor of the current block is represented by MV1, where MV1=(d1/d0)×MV0.

Thus, through implementation of the embodiment, the motion vector prediction of the current block may be simply and accurately implemented by using the ratio and a multiplication operation, thereby obtaining the first motion vector predictor of the current block.

In an embodiment, the scaling, based on the first distance and the second distance, the motion vector of the reference block to obtain the first motion vector predictor may include:
scaling, based on the first distance and the second distance, the motion vector of the reference block to obtain a candidate motion vector predictor of the current block; and
adjusting, based on the first display position, the second display position, and the third display position, a direction of the candidate motion vector predictor to obtain the first motion vector predictor.

The candidate motion vector predictor is a motion vector predictor obtained by scaling the motion vector of the reference block by using the first distance between the current image and the co-located reference image and the second distance between the current image and the second reference image. The candidate motion vector predictor may be a final motion vector predictor corresponding to the current block, or may not be a final motion vector predictor corresponding to the current block. Therefore, the candidate motion vector predictor is referred to as a candidate motion vector predictor.

For example, the candidate motion vector predictor of the current block is represented by MV1′, where MV1′=(d1/d0)×MV0.

In the embodiment, the adjusting, based on the first display position, the second display position, and the third display position, a direction of the candidate motion vector predictor to obtain the first motion vector predictor may include the following two cases:

Case 1: When the first display position and the second display position are on the same side of the third display position, the direction of the candidate motion vector predictor is maintained unchanged, and the candidate motion vector predictor with an unchanged direction is used as the first motion vector predictor.

That is, in Case 1, the first display position of the co-located reference image and the second display position of the second reference image are on the same side of the third display position of the current image. In this case, the direction of the candidate motion vector predictor needs to be maintained unchanged. Accordingly, the candidate motion vector predictor with the unchanged direction is the final first motion vector predictor corresponding to the current block.

In some embodiments, the first display position of the co-located reference image and the second display position of the second reference image are on the same side of the third display position of the current image, which may include: both the co-located reference image and the second reference image being on a left side of the current image; or both the co-located reference image and the second reference image being on a right side of the current image.

For example, continuing with the foregoing example, assuming that the first display position of the co-located reference image and the second display position of the second reference image are on the same side of the third display position of the current image, the direction of the candidate motion vector predictor MV1′ is maintained unchanged, and in this case, the motion vector predictor MV1=MV1′=(d1/d0)×MV0.

Case 2: When the first display position and the second display position are on different sides of the third display position, respectively, the direction of the candidate motion vector predictor is adjusted to an opposite direction, and an adjusted candidate motion vector predictor is used as the first motion vector predictor.

That is, in Case 2, the first display position of the co-located reference image and the second display position of the second reference image are on the different sides of the third display position of the current image, respectively. In this case, the direction of the candidate motion vector predictor needs to be adjusted to the opposite direction. Accordingly, the candidate motion vector predictor in the opposite direction is the final first motion vector predictor corresponding to the current block.

In some embodiments, the first display position of the co-located reference image and the second display position of the second reference image are on different sides of the third display position of the current image, respectively, which may include: the co-located reference image being on the left side of the current image, and the second reference image being on the right side of the current image; or the co-located reference image being on the right side of the current image, and the second reference image being on the left side of the current image.

For example, in the foregoing example, assuming that the first display position of the co-located reference image and the second display position of the second reference image are on the different sides of the third display position of the current image, the direction of the candidate motion vector predictor MV1′ is adjusted to the opposite direction, and in this case, the motion vector predictor MV1=−1×MV1′=−1×(d1/d0)×MV0.

Thus, through implementation of the embodiment, the direction of the candidate motion vector predictor is adjusted by using the display positions of the co-located reference image, the second reference image, and the current image in the video, taking into account relative directional relationships between the current image and the co-located reference image and between the current image and the second reference image, thereby improving accuracy of motion vector prediction of the current block.

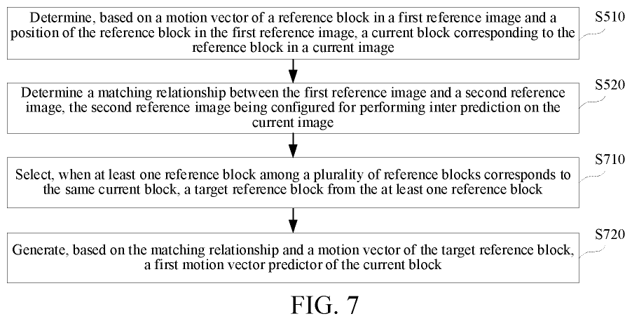

In an embodiment of this disclosure, another image processing method is provided. As shown in FIG. 7, the image processing method performed by an electronic device may include operations S710 to S720, and operations S510 to S520.

In the embodiment of this disclosure, there are a plurality of reference blocks. For example, R_B represents a reference block set, and R_b represents a reference block.

$$R\_B = \{ R\_b1 , R\_b2 , … R\_b ( n - 1 ) , R\_bn \} , where n \geq 2 .$$

For ease of understanding, FIG. 6B is a schematic diagram of another correspondence relationship between a reference block in a first reference image and a current block in a current image. As shown in FIG. 6B, the first reference image includes a reference block R_b1 and a reference block R_b2. The reference block R_b1 corresponds to a current block C_b1 in the current image, and the reference block R_b2 corresponds to a current block C_b2 in the current image. In FIG. 6B, current blocks corresponding to at least one reference block are different. In other words, one current block corresponds to one reference block. For a case shown in FIG. 6B, a motion vector of the reference block may be explicitly acquired, because at this time, the current block corresponds to only one reference block, and the motion vector of the reference block corresponding to the current block may be directly acquired.

For ease of understanding, FIG. 6C is a schematic diagram of another correspondence relationship between a reference block in a first reference image and a current block in a current image. As shown in FIG. 6C, the first reference image includes a reference block R_b1 and a reference block R_b2. The reference block R_b1 corresponds to a current block C_b1 in the current image, and the reference block R_b2 corresponds to a current block C_b2 in the current image. In FIG. 6C, current blocks corresponding to at least one reference block are different. In other words, one current block corresponds to one reference block. Meanwhile, a position of the reference block R_b1 in the first reference image is the same as a position of the current block C_b1 in the current image. That is, an object corresponding to the reference block R_b1 is the same as an object corresponding to the current block C_b1, and the object is a stationary object. In some embodiments, the correspondence relationship between the reference block in the first reference image and the current block in the current image may be established for a moving object. That is, the correspondence relationship between the reference block R_b2 and the current block C_b2 is established, to obtain a motion vector predictor of the current block C_b2. Prediction may be performed for the current block C_b1 in another temporal prediction mode, to obtain a motion vector predictor of the current block C_b1. For a case shown in FIG. 6C, a motion vector of the reference block may alternatively be explicitly acquired, because at this time, the current block corresponds to only one reference block, and the motion vector of the reference block corresponding to the current block may be directly acquired.

For ease of understanding, FIG. 6D is a schematic diagram of another correspondence relationship between a reference block in a first reference image and a current block in a current image. As shown in FIG. 6D, the first reference image includes a reference block R_b1 and a reference block R_b2. The reference block R_b1 corresponds to a current block C_b1 in the current image, and the reference block R_b2 also corresponds to the current block C_b1 in the current image. In FIG. 6D, the current block corresponding to at least one reference block is the same. In other words, one current block corresponds to at least two reference blocks. For a case shown in FIG. 6D, because the current block corresponds to at least two reference blocks at this time, motion vectors of the reference blocks may not be explicitly acquired. That is, a corresponding processing process exists. A specific processing process includes the following operations S710 to S720:

Operation S710: Select, when at least one reference block among the plurality of reference blocks corresponds to the same current block, a target reference block from the at least one reference block.

When the case shown in FIG. 6D occurs, in the embodiment of this disclosure, the target reference block may be selected from the at least one reference block. The target reference block is a reference block selected from the at least one reference block, so that a first motion vector predictor of the current block is generated based on a motion vector corresponding to the selected reference block.

In an embodiment of this disclosure, a current block corresponding to each reference block of the plurality of reference blocks is sequentially determined according to a preset order. In operation S710, the selecting a target reference block from the at least one reference block may include:
acquiring, based on the preset order, an ordering of the at least one reference block; and
selecting, based on the ordering, the target reference block from the at least one reference block.

When there are a plurality of reference blocks, in an embodiment, the current blocks corresponding to the reference blocks are sequentially derived according to the preset order, that is, serially derived, to help ensure derivation accuracy, thereby improving accuracy of generating a motion vector predictor of the current block. For example, in FIG. 6D, the reference block R_b1 may be first derived to obtain the current block C_b1 corresponding to the reference block R_b1, and then the reference block R_b2 is derived to obtain the current block C_b1 corresponding to the reference block R_b2. Accordingly, the order of derivation corresponding to the reference block R_b1 is first, and the order of derivation corresponding to the reference block R_b2 is later.

Therefore, in an embodiment, when the current block corresponding to the at least one reference block is the same, the at least one reference block may be ordered according to the preset order (that is, the foregoing derivation order), and then the target reference block is selected from the at least one reference block by using the ordering.

For example, the at least one reference block is R_b1, R_b2, R_b3, and R_b4, respectively. First, the reference block R_b1 is derived, then the reference block R_b2 is derived, then the reference block R_b3 is derived, and finally the reference block R_b4 is derived, to obtain an ordering L1=[R_b1, R_b2, R_b3, R_b4]. In this case, the target reference block may be selected from R_b1, R_b2, R_b3, and R_b4 by using the ordering L1.

For another example, in another embodiment, an ordering L2=[R_b4, R_b3, R_b2, R_b1] is obtained. In this case, the target reference block may be selected from R_b1, R_b2, R_b3, and R_b4 by using the ordering L2.

Thus, through implementation of the embodiment, the target reference block may be simply and accurately selected from the at least one reference block by using the ordering of the at least one reference block, providing strong support for motion vector prediction of the current block.

In an embodiment, the selecting, based on the ordering, the target reference block from the at least one reference block may include the following two modes:

Mode 1: Select, from the at least one reference block, a first reference block in the ordering as the target reference block.

That is, a reference block is directly selected as the target reference block.

In some embodiments, in the above embodiment with L1=[R_b1, R_b2, R_b3, R_b4], if the ordering is arranged from first to last, the reference block R_b1 is selected as the target reference block. If the ordering is arranged from last to first, the reference block R_b4 is selected as the target reference block.

Mode 2: Select, from the at least one reference block, a first specified number of reference blocks in the ordering as candidate reference blocks, the specified number being greater than or equal to 2, and select, from the specified number of candidate reference blocks, one candidate reference block as the target reference block.

In some embodiments, in the above embodiment with L1=[R_b1, R_b2, R_b3, R_b4], if the ordering is arranged from first to last, the reference block R_b1 and the reference block R_b2 are selected as candidate reference blocks. If the ordering is arranged from last to first, the reference block R_b3 and the reference block R_b4 are selected as candidate reference blocks.

In an embodiment, when there are a plurality of rounds of coding on the current image, a usage order of a plurality of candidate reference blocks may be preset, and then one candidate reference block may be selected from a specified number of candidate reference blocks as the target reference block according to the usage order.

For example, continuing with the foregoing example in which the reference block R_b1 and the reference block R_b2 are selected as candidate reference blocks, in a coding process of the current image in a current round, the reference block R_b1 may be selected as the target reference block, and in a coding process of the current image in a next round adjacent to the current round, the reference block R_b2 may be selected as the target reference block.

Alternatively, continuing with the foregoing example in which the reference block R_b4 and the reference block R_b3 are selected as candidate reference blocks, in a coding process of the current image in a current round, the reference block R_b4 may be selected as the target reference block, and in a coding process of the current image in a next round adjacent to the current round, the reference block R_b3 may be selected as the target reference block.

In other embodiments, the motion vectors corresponding to the specified number of candidate reference blocks may alternatively be averaged to obtain a motion vector average value, which is used as a first motion vector predictor of the current block.

In a practical application, a selection mode may be obtained according to an agreement between a decoding side and a coding side, and is not limited to the selection modes described in the foregoing.

Thus, through implementation of the embodiment, there are a plurality of selection modes, so that the target reference block may be flexibly selected from the at least one reference block, with high flexibility and applicability to various scenarios.

When there are a plurality of reference blocks, in an embodiment, parallel derivation may alternatively be performed, to help ensure derivation efficiency, thereby improving efficiency of generating a motion vector predictor of the current block. In a practical application, the derivation mode may be flexibly adjusted according to a specific application scenario.

Operation S720: Generate, based on the matching relationship and a motion vector of the target reference block, a first motion vector predictor of the current block.

In the embodiments of this disclosure, the target reference block is selected from the at least one reference block, and then calculation may be performed by using the motion vector of the target reference block and the matching relationship between the first reference image and the second reference image, to obtain the first motion vector predictor of the current block.

For descriptions of operations S510 to S520 shown in FIG. 7, reference may be made to operations S510 to S520 shown in FIG. 5. This is not described again herein.

In the embodiments of this disclosure, when the current block corresponding to the at least one reference block is the same, the target reference block may be selected from the at least one reference block in a selection mode agreed on by the coding side and the decoding side, so that the motion vector of the current block may be simply and accurately predicted by using the motion vector of the target reference block. This is applicable to many scenarios.

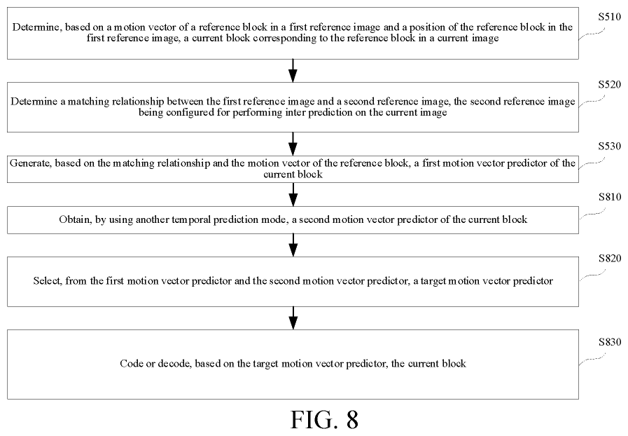

In an embodiment of this disclosure, another image processing method is provided. As shown in FIG. 8, the image processing method performed by an electronic device may further include the following operations S810 to S830 after operation S530:

Operation S810: Obtain, by using another temporal prediction mode, a second motion vector predictor of the current block.

In the embodiments of this disclosure, for the current block, the second motion vector predictor of the current block may alternatively be obtained in another temporal prediction mode other than operations 510 to 530. For example, the second motion vector predictor is determined based on a co-located block in the reference image. In some embodiments, when there is a plurality of co-located blocks, there may be a plurality of second motion vector predictors.

Operation S820: Select, from the first motion vector predictor and the second motion vector predictor, a target motion vector predictor.

In the embodiments of this disclosure, the target motion vector predictor is a motion vector predictor configured for coding the current block.

For example, continuing with the foregoing example of generating the first motion vector predictor MV1, second motion vector predictors are determined as MV2, MV3, and MV4, respectively, and in this case, one is selected from MV1, MV2, MV3, and MV4 as a target motion vector predictor.

Operation S830: Code or decode, based on the target motion vector predictor, the current block.

In the embodiments of this disclosure, the target motion vector predictor is obtained, then a residual value may be obtained by using the target motion vector predictor, and then processing sequentially enters a transform and quantization stage, an entropy coding stage, a loop filtering stage, and the like, to implement coding of the current block, that is, implement coding of the current image, and transmit corresponding coded data to a decoding side. After receiving the corresponding coded data, the decoding side decodes according to a decoding process, thereby reconstructing the current image.

For descriptions of operations S510 to S530 shown in FIG. 8, reference may be made to operations S510 to S530 shown in FIG. 5. This is not described again herein.

In the embodiments of this disclosure, the target motion vector predictor is selected from the at least two motion vector predictors corresponding to the current block to perform motion vector prediction of the current block, thereby implementing coding of the current block, and improving accuracy and efficiency of coding of the current block.

The following describes a specific scenario of the embodiments of this disclosure in detail.

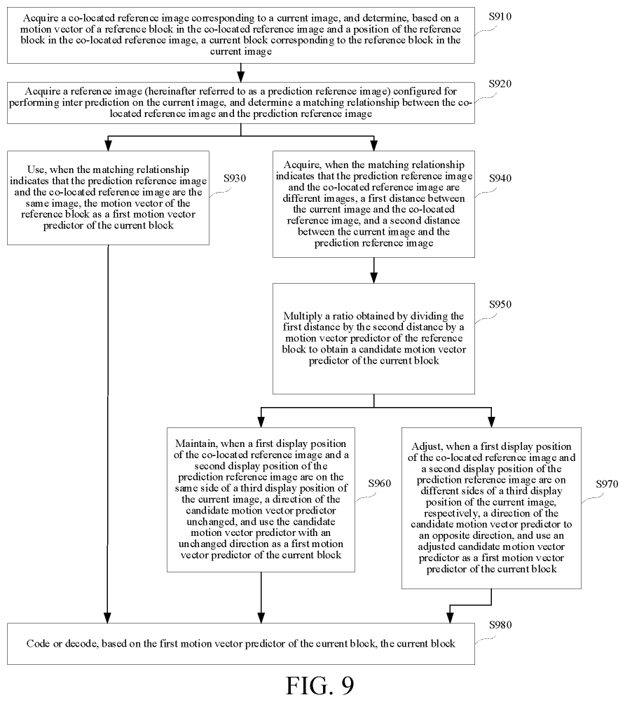

FIG. 9 is a flowchart of an image processing method according to an embodiment of this disclosure. The above first reference image refers to a co-located reference image, and the above second reference image is a prediction reference image. As shown in FIG. 9, the image processing method performed by an electronic device includes operations S910 to S980. Detailed descriptions are as follows.

Operation S910: Acquire a co-located reference image corresponding to a current image, and determine, based on a motion vector of a reference block in the co-located reference image and a position of the reference block in the co-located reference image, a current block corresponding to the reference block in the current image.

In some embodiments, the motion vector includes a motion vector predictor of the reference block, and the position of the reference block in the co-located reference image includes a position coordinate. Accordingly, a target position coordinate is calculated based on the motion vector predictor of the reference block and the position coordinate. A target block corresponding to the target position coordinate is determined in the current image, and the target block is used as the current block corresponding to the reference block in the current image.

Operation S920: Acquire a reference image (hereinafter referred to as a prediction reference image) configured for performing inter prediction on the current image, and determine a matching relationship between the co-located reference image and the prediction reference image.

Operation S930: Use, when the matching relationship indicates that the prediction reference image and the co-located reference image are the same image, the motion vector of the reference block as a first motion vector predictor of the current block, and perform operation S980.

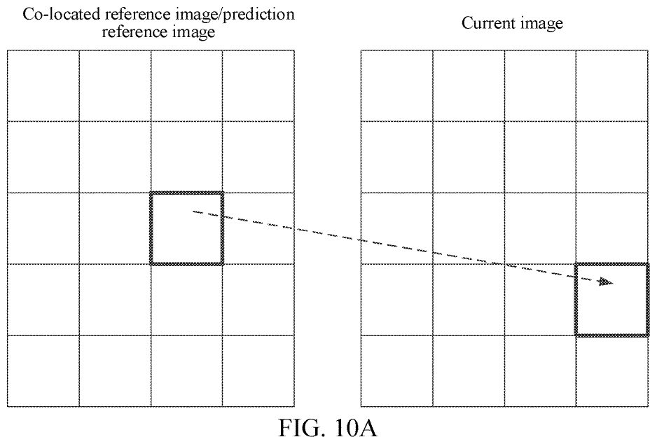

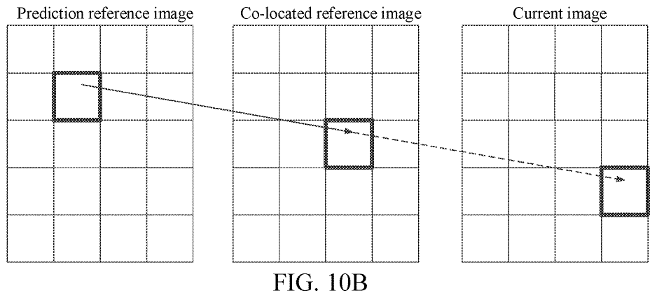

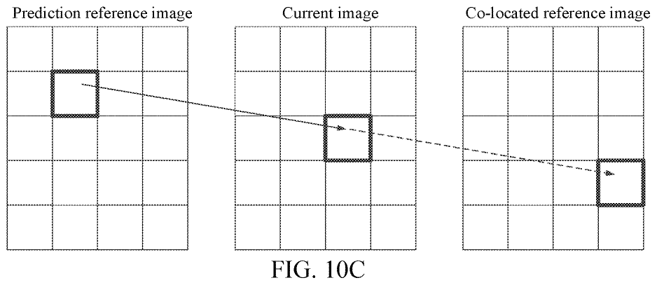

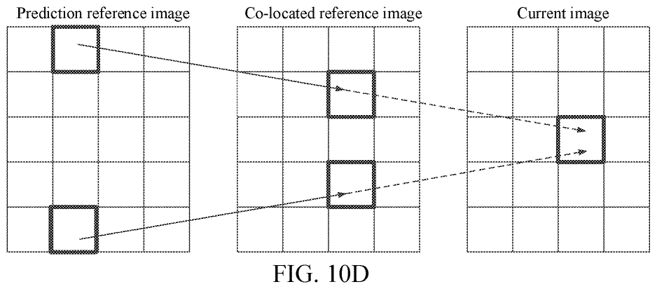

For ease of understanding, FIG. 10A is a schematic diagram of a prediction reference image, a co-located reference image, and a current image. As shown in FIG. 10A, the prediction reference image and the co-located reference image are the same image. A reference block in the co-located reference image corresponds to a current block in the current image. In this case, a motion vector predictor of the reference block in the co-located reference image is a first motion vector predictor of the current block in the current image.

Operation S940: Acquire, when the matching relationship indicates that the prediction reference image and the co-located reference image are different images, a first distance between the current image and the co-located reference image, and a second distance between the current image and the prediction reference image.

For ease of understanding, FIG. 10B is another schematic diagram of a prediction reference image, a co-located reference image, and a current image. As shown in FIG. 10B, the prediction reference image and the co-located reference image are different images. In some embodiments, the prediction reference image may be a reference image of the co-located reference image. A reference block in the co-located reference image corresponds to a current block in the current image. A reference block in the reference image of the co-located reference image also corresponds to the current block in the current image. In addition, the prediction reference image and the co-located reference image are located on the same side (i.e., both are on the left side) of the current image.

For ease of understanding, FIG. 10C is another schematic diagram of a prediction reference image, a co-located reference image, and a current image. As shown in FIG. 10C, the prediction reference image and the co-located reference image are different images. In some embodiments, the prediction reference image may be a reference image of the co-located reference image. A reference block in the co-located reference image corresponds to a current block in the current image. A reference block in the reference image of the co-located reference image corresponds to the reference block in the co-located reference image. In addition, the prediction reference image and the co-located reference image are located on different sides (i.e., one is on the left side and the other is on the right side) of the current image.

Based on the embodiments shown in FIG. 10B and FIG. 10C, and according to a principle of object motion continuity, assuming that an object moves in a uniform linear motion in continuous images and a relative distance from a camera remains substantially unchanged, a position to which a block moves in the current image may be derived in reverse based on a motion vector of the block in a reference frame. Through such derivation, a motion vector prediction map based on motion continuity may be constructed for the current image, indicating a matching position of the block of the current image in the reference image, that is, a motion vector.

Operation S950: Multiply a ratio obtained by dividing the first distance by the second distance by a motion vector predictor of the reference block to obtain a candidate motion vector predictor of the current block.

For example, continuing with the foregoing example in FIG. 10B, assuming that the first distance between the current image and the co-located reference image is d0, the second distance between the current image and the prediction reference image is d1, and the motion vector predictor of the reference block is MV0, the candidate motion vector predictor of the current block is MV1′=(d1/d0)×MV0.

Alternatively, continuing with the foregoing example in FIG. 10C, assuming that the first distance between the current image and the co-located reference image is d2, the second distance between the current image and the prediction reference image is d3, and the motion vector predictor of the reference block is MV0, the candidate motion vector predictor of the current block is MV1′=(d3/d2)×MV0.

Operation S960: Maintain, when a first display position of the co-located reference image and a second display position of the prediction reference image are on the same side of a third display position of the current image, a direction of the candidate motion vector predictor unchanged, and use the candidate motion vector predictor with an unchanged direction as a first motion vector predictor of the current block.

For example, continuing with the foregoing example in FIG. 10B, the first motion vector predictor of the current block is MV1=MV1′=(d1/d0)×MV0.

Operation S970: Adjust, when a first display position of the co-located reference image and a second display position of the prediction reference image are on different sides of a third display position of the current image, respectively, a direction of the candidate motion vector predictor to an opposite direction, and use an adjusted candidate motion vector predictor as a first motion vector predictor of the current block.

For example, continuing with the foregoing example in FIG. 10C, the first motion vector predictor of the current block is MV1=−1×MV1′=−1×(d3/d2)×MV0.

Operation S980: Code or decode, based on the first motion vector predictor of the current block, the current block.

In other embodiments, there may be a plurality of reference blocks in the co-located reference image. Accordingly, there may alternatively be a plurality of reference blocks in the prediction reference image. At least one reference block in the co-located reference image may correspond to the same current block in the current image.

In an embodiment, according to a motion continuity model, motion vectors of reference images may have the following case: a plurality of motion blocks are mapped to the same position in a current image. FIG. 10D is another schematic diagram of a prediction reference image, a co-located reference image, and a current image. As shown in FIG. 10D, the prediction reference image and the co-located reference image are different images. In some embodiments, the prediction reference image may be a reference image of the co-located reference image. Two different reference blocks in the co-located reference image both correspond to a current block in the current image after motion, and two different reference blocks in the reference image of the co-located reference image also correspond to the current block in the current image after motion. In this case, a coding side and a decoding side agree on a common principle of how to select a predictor.

In some embodiments, in this case, a target reference block may be selected from the co-located reference image according to a specified selection mode, and then calculation is performed by using a motion vector of the target reference block and a matching relationship between the co-located reference image and the prediction reference image, to obtain a first motion vector predictor of the current block. For a specific process, reference may be made to descriptions of the foregoing embodiments, which are not repeated herein.

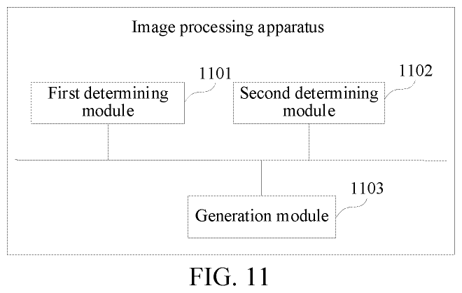

FIG. 11 is a block diagram of an image processing apparatus according to an embodiment of this disclosure. As shown in FIG. 11, the apparatus includes:
a first determining module 1101, configured to determine, based on a motion vector of a reference block in a first reference image and a position of the reference block in the first reference image, a current block corresponding to the reference block in a current image;
a second determining module 1102, configured to determine a matching relationship between the first reference image and a second reference image, the second reference image being configured for performing inter prediction on the current image; and
a generation module 1103, configured to generate, based on the matching relationship and the motion vector of the reference block, a first motion vector predictor of the current block.

In an embodiment of this disclosure, based on the foregoing solution, the first reference image includes a co-located reference image corresponding to the current image. The generation module 1103 is configured to: use, when the matching relationship indicates that the second reference image and the co-located reference image are the same image, the motion vector of the reference block as the first motion vector predictor; and scale, when the matching relationship indicates that the second reference image and the co-located reference image are different images, the motion vector of the reference block to obtain the first motion vector predictor.

In an embodiment of this disclosure, based on the foregoing solution, the generation module 1103 is further configured to: acquire a first distance between the current image and the co-located reference image, and a second distance between the current image and the second reference image; and scale, based on the first distance and the second distance, the motion vector of the reference block to obtain the first motion vector predictor.

In an embodiment of this disclosure, based on the foregoing solution, the generation module 1103 is further configured to: multiply a ratio obtained by dividing the first distance by the second distance by the motion vector of the reference block, to obtain the first motion vector predictor.

In an embodiment of this disclosure, based on the foregoing solution, the co-located reference image, the second reference image, and the current image are images within the same video. The generation module 1103 is further configured to: acquire a first display position of the co-located reference image in the video, a second display position of the second reference image in the video, and a third display position of the current image in the video; determine, based on the third display position and the first display position, the first distance; and determine, based on the third display position and the second display position, the second distance.

In an embodiment of this disclosure, based on the foregoing solution, the generation module 1103 is further configured to: scale, based on the first distance and the second distance, the motion vector of the reference block to obtain a candidate motion vector predictor of the current block; and adjust, based on the first display position, the second display position, and the third display position, a direction of the candidate motion vector predictor to obtain the first motion vector predictor.

In an embodiment of this disclosure, based on the foregoing solution, the generation module 1103 is further configured to: maintain, when the first display position and the second display position are on the same side of the third display position, the direction of the candidate motion vector predictor unchanged, and use the candidate motion vector predictor with an unchanged direction as the first motion vector predictor; and adjust, when the first display position and the second display position are on different sides of the third display position, respectively, the direction of the candidate motion vector predictor to an opposite direction, and use an adjusted candidate motion vector predictor as the first motion vector predictor.

In an embodiment of this disclosure, based on the foregoing solution, the reference block includes a plurality of reference blocks. The generation module 1103 is configured to: select, when at least one reference block among the plurality of reference blocks corresponds to the same current block, a target reference block from the at least one reference block; and generate, based on the matching relationship and a motion vector of the target reference block, the first motion vector predictor.

In an embodiment of this disclosure, based on the foregoing solution, the generation module 1103 is further configured to: acquire, based on the preset order, an ordering of the at least one reference block; and select, based on the ordering, the target reference block from the at least one reference block.

In an embodiment of this disclosure, based on the foregoing solution, the generation module 1103 is further configured to: select, from the at least one reference block, a first reference block in the ordering as the target reference block; or select, from the at least one reference block, a first specified number of reference blocks in the ordering as candidate reference blocks, the specified number being greater than or equal to 2, and select, from the specified number of candidate reference blocks, one candidate reference block as the target reference block.

In an embodiment of this disclosure, based on the foregoing solution, the motion vector includes a motion vector predictor of the reference block, and the position of the reference block in the first reference image includes a position coordinate; and the first determining module 1101 is further configured to: calculate, based on the motion vector predictor of the reference block and the position coordinate, a target position coordinate; and determine an image block indicated by the target position coordinate in the current image as the current block.

In an embodiment of this disclosure, based on the foregoing solution, the apparatus further includes a coding and decoding module, configured to: determine, by using another temporal prediction mode, a second motion vector predictor of the current block; select, from the first motion vector predictor and the second motion vector predictor, a target motion vector predictor; and code or decode, based on the target motion vector predictor, the current block.

The image processing apparatus provided in the above embodiment and the image processing method provided in the above embodiment belong to the same idea. Modes in which the various modules and units perform operations have been described in further detail in the method embodiments. This is not described again herein. In practical applications, the image processing apparatus provided in the above embodiment may allocate the above functions to different functional modules as indicated, that is, divide an internal structure of the apparatus into different functional modules to complete all or part of the functions described above, which is also not limited herein.

The embodiments of this disclosure further provide an electronic device, including at least one processor; a memory, configured to store at least one computer program, the at least one computer program, when executed by the at least one processor, causing the electronic device to implement the image processing method provided in the above embodiments.

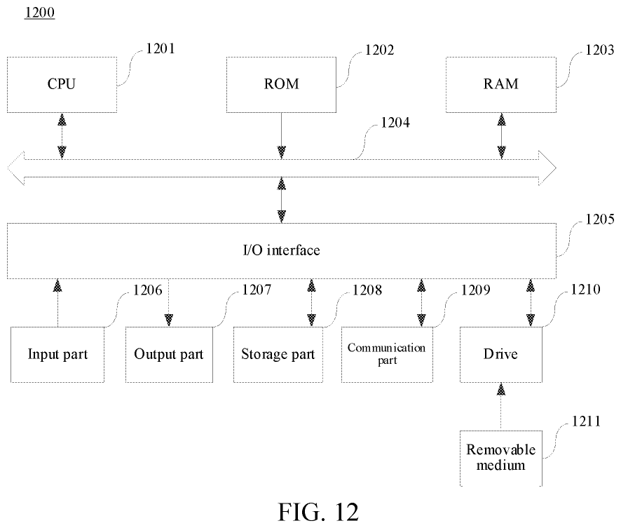

FIG. 12 is a schematic structural diagram of an electronic device suitable for implementing embodiments of this disclosure. The electronic device 1200 shown in FIG. 12 is an example, and does not constitute any limitation on functions and use ranges of the embodiments of this disclosure.

As shown in FIG. 12, a computer system 1200 includes a central processing unit (CPU) 1201, which may perform various suitable actions and processing based on a program stored in a read-only memory (ROM) 1202 or a program loaded from a storage part 1208 into a random access memory (RAM) 1203, for example, perform the method described in the above embodiments. The RAM 1203 further stores various programs and data required for system operations. The CPU 1201, the ROM 1202, and the RAM 1203 are connected to each other through a bus 1204. An input/output (I/O) interface 1205 is also connected to the bus 1204.

The following components are connected to the I/O interface 1205: an input part 1206 including a keyboard, a mouse, or the like; an output part 1207 including a cathode ray tube (CRT), a liquid crystal display (LCD), a speaker, or the like; a storage part 1208 including a hard disk, or the like; and a communication part 1209 including a network interface card such as a local area network (LAN) card or a modem. The communication part 1209 performs communication processing by using a network such as the Internet. A driver 1210 is also connected to the I/O interface 1205 as required. A removable medium 1211, such as a magnetic disk, an optical disc, a magneto-optical disk, or a semiconductor memory, is installed on the drive 1210 as required, so that a computer program read from the removable medium is installed into the storage part 1208 as required.

For example, according to an embodiment of this disclosure, the processes described above with reference to the flowcharts may be implemented as computer software programs. For example, an embodiment of this disclosure includes a computer program product. The computer program product includes a computer program stored in a computer-readable medium. The computer program includes a computer program configured to perform a method shown in the flowchart. In such an embodiment, the computer program may be downloaded and installed from a network through the communication part 1209, and/or installed from the removable medium 1211. When the computer program is executed by the CPU 1201, the various functions defined in a system of this disclosure are executed.

The computer-readable medium shown in the embodiments of this disclosure may be a computer-readable signal medium or a non-transitory computer-readable storage medium or any combination of the two. A more specific example of the non-transitory computer-readable storage medium may include but is not limited to: an electrical connection having at least one wire, a portable computer magnetic disk, a hard disk, a random access memory (RAM), a read-only memory (ROM), an erasable programmable read-only memory (EPROM), a flash memory, an optical fiber, a compact disk read-only memory (CD-ROM), an optical storage device, a magnetic storage device, or any suitable combination thereof. The computer program included in the computer-readable medium may be transmitted by using any suitable medium, including but not limited to: a wireless medium, a wire, or the like, or any suitable combination thereof.

The flowcharts and block diagrams in the accompanying drawings illustrate possible system architectures, functions and operations that may be implemented by a system, a method, and a computer program product according to various embodiments of this disclosure. Each block in a flowchart or a block diagram may represent a module, a program segment, or a part of code. The module, the program segment, or the part of code includes at least one executable instruction configured for implementing specified logic functions. In some implementations used as substitutes, functions annotated in the blocks may alternatively occur in a sequence different from that annotated in the accompanying drawings. For example, actually two blocks shown in succession may be performed basically in parallel, and sometimes the two blocks may be performed in a reverse sequence. This is determined by a related function. Each block in a block diagram and/or a flowchart and a combination of blocks in the block diagram and/or the flowchart may be implemented by using a dedicated hardware-based system configured to perform a specified function or operation, or may be implemented by using a combination of dedicated hardware and a computer instruction.

A related unit described in the embodiments of this disclosure may be implemented in a software manner, or may be implemented in a hardware manner, and the unit described may alternatively be set in a processor. Names of the units do not constitute a limitation on the units in a specific case.

Another aspect of this disclosure further includes a computer-readable storage medium, such as as non-transitory computer-readable storage medium, having a computer program stored therein. The computer program, when executed by a processor, implements the image processing method as described above. The computer-readable storage medium may be included in the electronic device described in the above embodiments, or may exist alone without being installed into the electronic device.

According to another aspect of this disclosure, a computer program product or a computer program is provided, the computer program product or the computer program including computer instructions, the computer instructions being stored in a computer-readable storage medium. A processor of a computer device reads the computer instructions from the computer-readable storage medium, and the processor executes the computer instructions to cause the computer device to perform the image processing method provided in the above various embodiments.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include A, B, C or any combination thereof. References to one of A or B and one of A and B are intended to include A or B or (A and B). The use of “one of” does not preclude any combination of the recited elements when applicable, such as when the elements are not mutually exclusive.

The foregoing disclosure includes some embodiments of this disclosure which are not intended to limit the scope of this disclosure. Other embodiments shall also fall within the scope of this disclosure.

What is claimed is:

1. A method of image processing, comprising:
determining, based on a motion vector of a reference block in a first reference picture of a current picture and a position of the reference block in the first reference picture, a current block in the current picture corresponding to the reference block;
determining a matching relationship between the first reference picture and a second reference picture that is used in an inter prediction for the current picture; and
generating, based on the matching relationship and the motion vector of the reference block, a first motion vector predictor of the current block.

2. The method according to claim 1, wherein the first reference picture is a co-located reference picture of the current picture, and the generating the first motion vector predictor comprises:
using, when the matching relationship indicates that the second reference picture and the co-located reference picture are of a same picture, the motion vector of the reference block as the first motion vector predictor; and
scaling, when the matching relationship indicates that the second reference picture and the co-located reference picture are of different pictures, the motion vector of the reference block to obtain the first motion vector predictor.

3. The method according to claim 2, wherein the scaling the motion vector comprises:
acquiring a first distance between the current picture and the co-located reference picture, and a second distance between the current picture and the second reference picture; and
scaling, based on the first distance and the second distance, the motion vector of the reference block to obtain the first motion vector predictor.

4. The method according to claim 3, wherein the scaling the motion vector comprises:
multiplying a ratio of the second distance to the first distance with the motion vector of the reference block to obtain the first motion vector predictor.

5. The method according to claim 3, wherein the co-located reference picture, the second reference picture, and the current picture are within a same video, and the acquiring the first distance and the second distance comprises:
acquiring a first display position of the co-located reference picture in the video, a second display position of the second reference picture in the video, and a third display position of the current picture in the video;
determining, based on the third display position and the first display position, the first distance; and
determining, based on the third display position and the second display position, the second distance.

6. The method according to claim 5, wherein the scaling the motion vector comprises:
scaling, based on the first distance and the second distance, the motion vector of the reference block to obtain a candidate motion vector predictor of the current block; and
adjusting, based on the first display position, the second display position, and the third display position, a direction of the candidate motion vector predictor to obtain the first motion vector predictor.

7. The method according to claim 6, wherein the adjusting the direction of the candidate motion vector predictor to obtain the first motion vector predictor comprises:
when the first display position and the second display position are on a same side of the third display position, using the candidate motion vector predictor without a direction change as the first motion vector predictor; and
when the first display position and the second display position are on different sides of the third display position, using an opposite of the candidate motion vector predictor as the first motion vector predictor.

8. The method according to claim 1, wherein a plurality of reference blocks in the first reference picture correspond to the current block in the current picture, and the generating the first motion vector predictor of the current block comprises:
selecting the reference block from the plurality of reference blocks.

9. The method according to claim 8, wherein the selecting the reference block comprises:
acquiring, based on a preset order, an ordering of the plurality of reference blocks; and
selecting, based on the ordering, the reference block from the plurality of reference blocks.

10. The method according to claim 9, wherein the selecting the reference block comprises:
selecting, from the plurality of reference blocks, a first reference block according to the ordering as the reference block.

11. The method according to claim 9, wherein the selecting the reference block comprises:
selecting, from the plurality of reference blocks, a specified number of reference blocks according to the ordering as candidate reference blocks, the specified number being greater than or equal to 2, and
selecting, from the candidate reference blocks, one candidate reference block as the reference block.

12. The method according to claim 1, wherein the determining the current block comprises:
calculating, based on the motion vector of the reference block and the position of the reference block, a target position coordinate in the current picture; and
determining the current block according to the target position coordinate.

13. The method according to claim 1, further comprising:
determining, by using another temporal prediction mode, a second motion vector predictor of the current block;
selecting, from the first motion vector predictor and the second motion vector predictor, a target motion vector predictor; and
encoding or decoding the current block based on the target motion vector predictor.

14. An apparatus for image processing, comprising processing circuitry configured to:
determine, based on a motion vector of a reference block in a first reference picture of a current picture and a position of the reference block in the first reference picture, a current block in the current picture corresponding to the reference block;
determine a matching relationship between the first reference picture and a second reference picture that is used in an inter prediction for the current picture; and
generate, based on the matching relationship and the motion vector of the reference block, a first motion vector predictor of the current block.

15. The apparatus according to claim 14, wherein the first reference picture is a co-located reference picture of the current picture and the processing circuitry is configured to:
use, when the matching relationship indicates that the second reference picture and the co-located reference picture are of a same picture, the motion vector of the reference block as the first motion vector predictor; and
scale, when the matching relationship indicates that the second reference picture and the co-located reference picture are of different pictures, the motion vector of the reference block to obtain the first motion vector predictor.

16. The apparatus according to claim 15, wherein the processing circuitry is configured to:
acquire a first distance between the current picture and the co-located reference picture, and a second distance between the current picture and the second reference picture; and
scale, based on the first distance and the second distance, the motion vector of the reference block to obtain the first motion vector predictor.

17. The apparatus according to claim 16, wherein the processing circuitry is configured to:
multiply a ratio of the second distance to the first distance with the motion vector of the reference block to obtain the first motion vector predictor.

18. The apparatus according to claim 16, wherein the co-located reference picture, the second reference picture, and the current picture are within a same video, the processing circuitry is configured to:
acquire a first display position of the co-located reference picture in the video, a second display position of the second reference picture in the video, and a third display position of the current picture in the video;
determine, based on the third display position and the first display position, the first distance; and
determine, based on the third display position and the second display position, the second distance.

19. The apparatus according to claim 18, wherein the processing circuitry is configured to:
scale, based on the first distance and the second distance, the motion vector of the reference block to obtain a candidate motion vector predictor of the current block; and
adjust, based on the first display position, the second display position, and the third display position, a direction of the candidate motion vector predictor to obtain the first motion vector predictor.

20. A non-transitory computer-readable storage medium storing instructions which when executed by a processor cause the processor to perform a method of encoding a bitstream, the method comprising:
determining, based on a motion vector of a reference block in a first reference picture of a current picture and a position of the reference block in the first reference picture, a current block in the current picture corresponding to the reference block;
determining a matching relationship between the first reference picture and a second reference picture that is used in an inter prediction for the current picture;
generating, based on the matching relationship and the motion vector of the reference block, a first motion vector predictor of the current block;
encoding the current block into coded information in the bitstream based on the first motion vector predictor; and
transmitting the bitstream.
